(19) United States
(12) Patent Application Publication
(10) Pub. No.: US 2024/0312138 A1
(43) Pub. Date: Sep. 19, 2024

(54) METHOD AND SYSTEM FOR MODELING ROOF IN A GEOGRAPHICAL LOCATION USING DIGITAL SURFACE MODEL DATA

(71) Applicant: Arka Energy Inc., Union City, CA (US)

(72) Inventors: Nikhil SHAJI, Kottayam (IN); Sharad ARORA, Varanasi (IN); Utkarsh Singh THAKUR, Jabalpur (IN)

(21) Appl. No.: 18/605,274

(22) Filed: Mar. 14, 2024

(30) Foreign Application Priority Data
Mar. 14, 2023 (IN) 202311017073

(51) Int. Cl. G06T 17/20; G06V 10/25

(52) U.S. Cl. CPC G06T 17/20; G06V 10/25

(57) ABSTRACT

Embodiments of present disclosure relate to a method (400) for modeling a roof in a geographical area for solar installation. The method may include steps of receiving a pre-defined area of a region of interest (ROI), obstructions selected by an entity from an input device (106), and generating a digital surface model (DSM) of the pre-defined area and obstructions selected by the entity. The method may also include obtaining DSM data of the pre-defined area and the obstructions, parsing the obtained DSM data, and correspondingly delivering a raster image and associated metadata. The method may further include creating a 3D mesh of a roof from the received raster image and the associated metadata, receiving parameters from the entity, and correspondingly creating and updating one or more roof models. Further, rendering on a graphical user interface, a visualization indicative of a plurality of solar panels over the pre-defined area.

### TECHNICAL FIELD

The present disclosure, in general, relates to geospatial modeling. More particularly, it relates to method and system for modeling roof in geographical location using digital surface model data.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

A digital surface model (DSM) is a representation of surface of earth, including tops of buildings and other structures, in a digital format. It is generated by collecting data from various sources such as lidar, photogrammetry, and other sensors. DSM data can provide highly accurate measurements of the elevations of different features on the earth's surface. The DSM data can be used to create 3D models of roofs and other obstructions, which can be useful for a variety of applications. For example, in construction industry, 3D models of roofs can be used for building design and planning, allowing architects and engineers to visualize the finished structure and identify potential issues before construction begins. In insurance industry, 3D models of roofs can be used to assess damage from natural disasters, such as hurricanes or tornadoes, and to estimate the cost of repairs. In solar industry, 3D modeling of solar panel prior to installation can be used to evaluate cost of installation. Further, obstruction models may also be used for aviation safety, allowing air traffic controllers to identify potential hazards to aircraft in the vicinity of an airport or other airfield. In telecommunications industry, 3D models of obstructions may be used for site selection and tower construction, helping to identify areas where signal coverage may be limited or obstructed.

In existing modeling technique, 3D Roof creation and designing in a 2D plane is a very tedious process. Without any prior knowledge about 3D parameters of a roof such as tilt, height, and storeys, roof creation may not be accurate to real-world roofs which may hamper solar generation estimates and produce wrong data.

There is, therefore, a need to overcome the above drawback, limitations, and shortcomings associated with the existing line drawing techniques by providing a solution to automate process of modeling roof and obstructions in a geographical location quickly and accurately.

### Objects of the Present Disclosure

Some of the objects of the present disclosure, which at least one embodiment herein satisfy are as listed herein below.

A general object of present disclosure is to overcome the above drawback, limitations, and shortcomings associated with the existing modeling technique by providing a solution to automate process of modeling roofs and obstructions in a geographical location.

Another object of the present disclosure is to provide a system and method for improving accuracy by using digital surface model (DSM) data to create 3D models, and the resulting models are highly accurate and precise, providing detailed information about shape, size, and elevation of roofs and obstructions.

Another object of the present disclosure is to provide a system and method for better visualization of structure of roofs and obstructions.

Another object of the present disclosure is to provide a system and method for creating 3D models using DSM data, thus costs associated with traditional surveying methods are reduced.

Another object of the present disclosure is to provide a system and method for reducing time taken in roof creation.

### SUMMARY

Various aspects of present disclosure relates to geospatial modeling. More particularly, it relates to method and system for modeling roof in geographical location using digital surface model data. The proposed system and method improve accuracy by using digital surface model (DSM) data to create 3D models, and the resulting models are highly accurate and precise, providing detailed information about shape, size, and elevation of roofs and obstructions, also reducing time taken in roof creation.

An aspect of present disclosure pertains to a method for modeling a roof in a geographical area for solar installation. The method may include steps of receiving a pre-defined area of a region of interest (ROI), one or more obstructions selected by an entity by an input device, and generating a digital surface model (DSM) of the pre-defined area and obstructions selected by the entity. The method may also include obtaining DSM data of the pre-defined area and the one or more obstructions selected by the entity, parsing the obtained DSM data, and correspondingly delivering a raster image and associated metadata. The method may further include creating a 3D mesh of a roof from the received raster image and the associated metadata, receiving parameters from the entity, and correspondingly creating and updating one or more roof models. Further, corresponding to the one or more roof models, rendering on a graphical user interface (GUI), a visualization indicative of a plurality of solar panels over the pre-defined area.

In an aspect, the parameters include any or a combination of core height, parapet height, tilt, and azimuth.

In an aspect, color coding in the 3D mesh based on height of each points.

In an aspect, the one or more roof models may be used for heat map generation that enables the entity to identify the roof and the one or more obstructions.

In an aspect, the obstructions may include any or combination of skylight, pole, chimney, vent, and tree in proximity of the roof.

According to another aspect of present disclosure, a system to model a roof in a geographical area for solar installation s disclosed. The system may include a processor configured to receive a pre-defined area of a region of interest (ROI) and obstructions in the pre-defined area, selected by an entity by an input device, and generate a digital surface model (DSM) of the pre-defined area and obstructions selected by the entity. Additionally, the processor may be configured to obtain DSM data of the pre-defined area and the obstructions, parse the obtained DSM data, and correspondingly delivers a raster image and associated metadata. Further, the processor may be configured to create a 3D mesh of a roof from the received raster image and the associated metadata and receive parameters from the entity, and correspondingly create and update one or more roof models. Further, corresponding to the roof models, renders, on a graphical user interface (GUI), a visualization indicative of a plurality of solar panels over the pre-defined area.

Various objects, features, aspects, and advantages of the present disclosure will become more apparent from the following detailed description of preferred embodiments, along with the accompanying drawing figures in which like numerals represent like features.

### BRIEF DESCRIPTION OF THE ACCOMPANYING DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a block diagram of a system to model a roof in a geographical location for solar installation, in accordance with an embodiment of the present disclosure.

FIG. 2A-2D illustrates exemplary interfaces, in accordance with an embodiment of the present disclosure.

FIG. 3 illustrates exemplary functional components of a processing engine of the system, in accordance with an embodiment of the present disclosure.

FIG. 4 illustrates a flow chart of a process for modeling model a roof in a geographical location, in accordance with an embodiment of the present disclosure.

FIG. 5 illustrates an exemplary computer system to implement proposed system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims. Embodiments of present disclosure relates to geospatial modeling. More particularly, it relates to method and system for modeling roof in a geographical location using digital surface model data.

According to an aspect of present disclosure a method for modeling a roof in a geographical area for solar installation is disclosed. The method may include steps of receiving a pre-defined area of a region of interest (ROI), one or more obstructions selected by an entity by an input device, and generating a digital surface model (DSM) of the pre-defined area and obstructions selected by the entity. The method may also include obtaining DSM data of the pre-defined area and the one or more obstructions selected by the entity, parsing the obtained DSM data, and correspondingly delivering a raster image and associated metadata. The method may further include creating a 3D mesh of a roof from the received raster image and the associated metadata, receiving parameters from the entity, and correspondingly creating and updating one or more roof models. Further, corresponding to the one or more roof models, rendering on a graphical user interface (GUI), a visualization indicative of a plurality of solar panels over the pre-defined area.

In an embodiment, the parameters may include any or a combination of core height, parapet height, tilt, and azimuth.

In an embodiment, color coding in the 3D mesh based on height of each points.

In an embodiment, the one or more roof models may be used for heat map generation that enables the entity to identify the roof and the one or more obstructions.

In an embodiment, the obstructions may include any or combination of skylight, pole, chimney, vent, and tree in proximity of the roof.

According to another embodiment of present disclosure, a system to model a roof in a geographical area for solar installation is disclosed. The system may include a processor configured to receive a pre-defined area of a region of interest (ROI) and obstructions in the pre-defined area, selected by an entity by an input device, and generate a digital surface model (DSM) of the pre-defined area and obstructions selected by the entity. Additionally, the processor may be configured to obtain DSM data of the pre-defined area and the obstructions, parse the obtained DSM data, and correspondingly delivers a raster image and associated metadata. Further, the processor may be configured to create a 3D mesh of a roof from the received raster image and the associated metadata and receive parameters from the entity, and correspondingly create and update one or more roof models. Further, corresponding to the roof models, renders, on a graphical user interface (GUI), a visualization indicative of a plurality of solar panels over the pre-defined area.

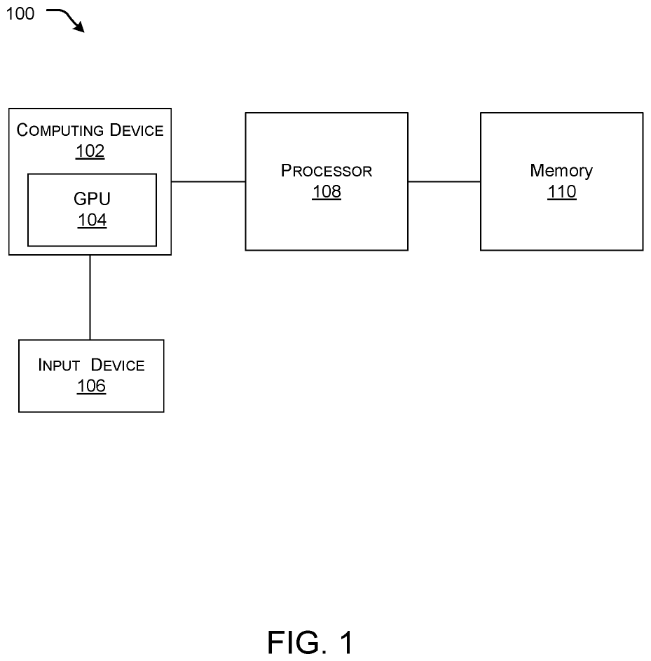

FIG. 1 illustrates a block diagram of a system to model a roof in a geographical location for solar installation, in accordance with an embodiment of the present disclosure.

As illustrated, a system 100 to model a roof in a geographical area for solar installation is disclosed. The geographical area can be a city that includes both buildings and terrain. As used herein, “building” means any manmade structure such as houses, office buildings, storage tanks, warehouses, sports arenas, or the like. As used herein, “terrain” is meant to include ground and vegetation such as trees, shrubs, forests, or the like present in the geographical area. The system 100 includes a computing device 102 having a graphical processing unit (GPU) 104, and the computing device 102 can be operatively coupled to an input device 106. The computing device 102 may correspond to various types of computing devices, such as, but not limited to, a desktop computer, a laptop, a PDA, a mobile device, a smartphone, a tablet computer, and the like. The input device may be selected from a group consisting of a mouse, keyboard, a joystick, or the like. The graphical processing unit (GPU) 104 acts as a processing unit for all graphical user interfaces (GUI) in the computing device. In an exemplary embodiment, the GPU renders graphics data inside the GUI and ensures that graphical data is displayed to the computing device 102. In addition, the GPU can be used for memory-intensive tasks like rendering images and videos, animations, and CAD tasks.

In an embodiment, the system 100 includes a processor 108 that can be communicatively coupled to the computing device 102, and a memory 110. The processor 108 includes suitable logic, circuitry, and/or interfaces that are operable to execute one or more instructions stored in the memory 114 to perform pre-determined operation of the system. The memory 110 may be operable to store the one or more instructions. The processor 108 may be implemented using one or more processor technologies known in the art. Examples of the processor 108 include but are not limited to, an x86 processor, a RISC processor, an ASIC processor, a CISC processor, an Arduino Uno board, an ESP 8266 node microcontroller, or any other processor.

The memory 110 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 110 includes the one or more instructions that are executable by the processor 108 to perform specific operations. It will be apparent to a person having ordinary skill in the art that the one or more instructions stored in the memory 110 enable multiple components of the system 100 to perform predetermined operations.

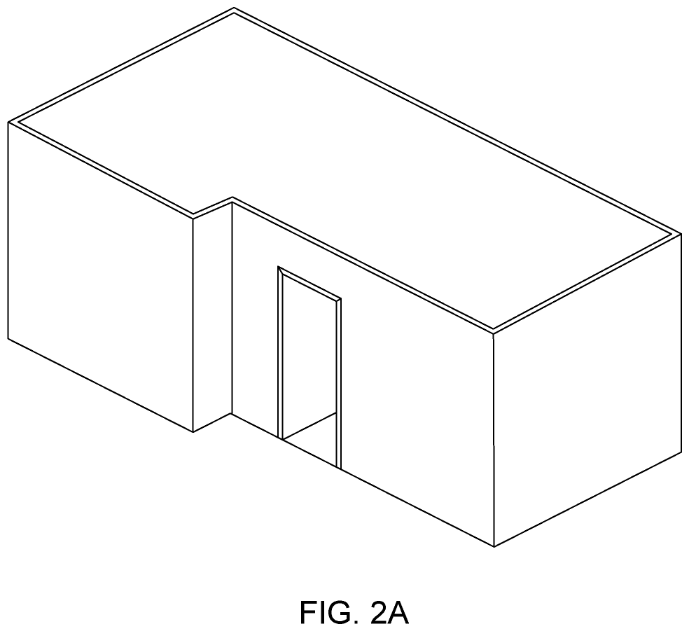

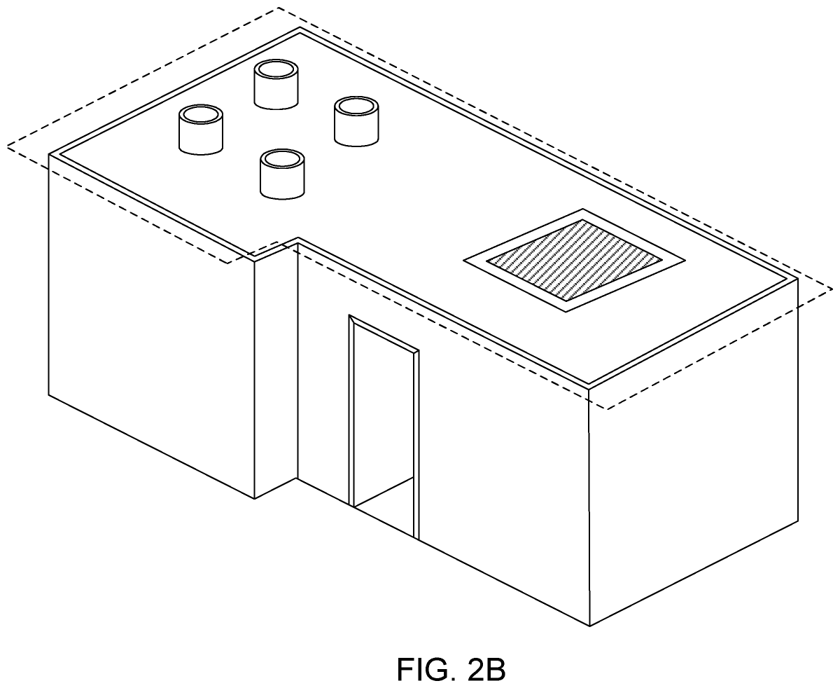

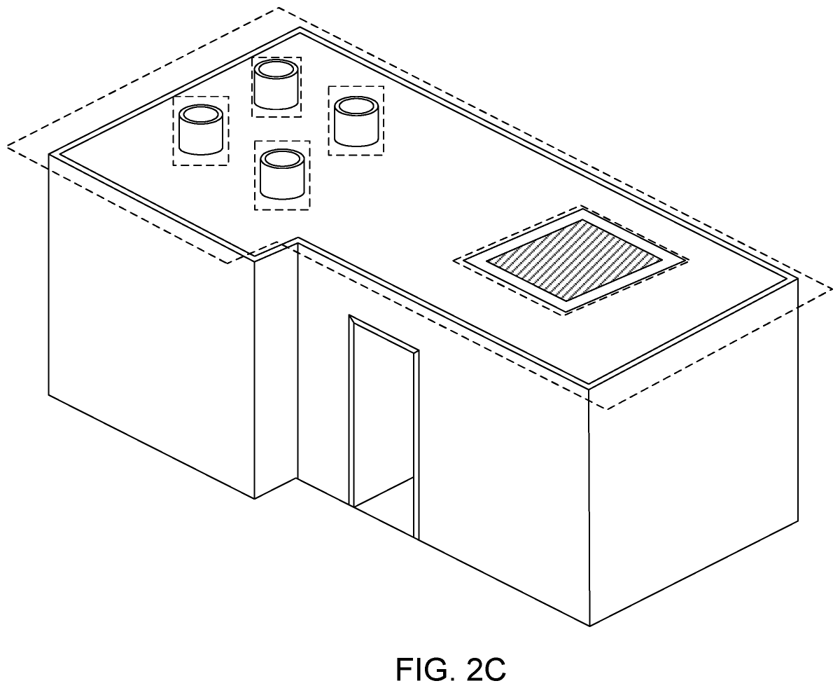

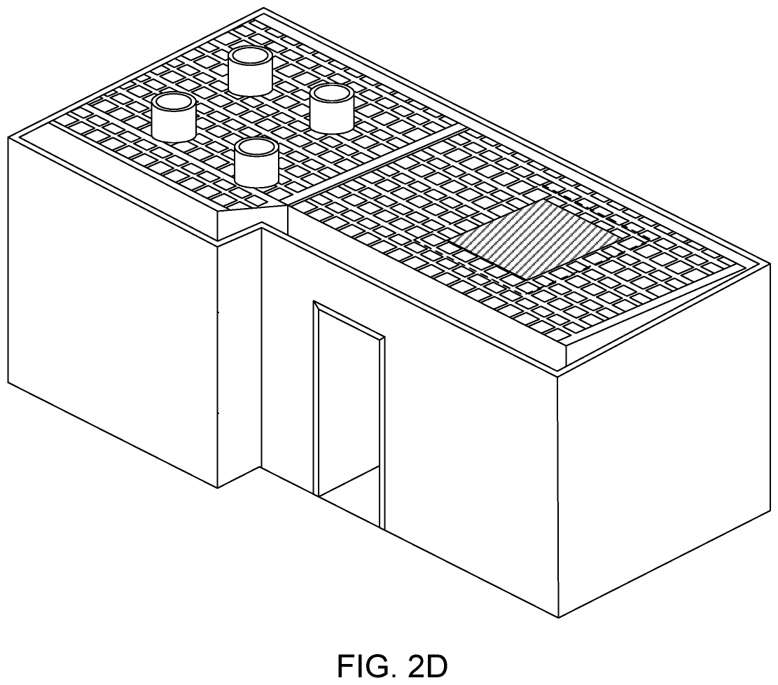

In an embodiment, the processor 108 may be configured to receive a first set of data packets pertaining to a pre-defined area of a region of interest (ROI). The pre-defined area is selected by an entity (i.e. user) by an input device, and the ROI can be roof of home, office, industry, or the like, where solar installation is required. In an exemplary embodiment, as shown in FIG. 2A, geographical location of the region of interest (ROI) is disclosed, and the user selects the roof of at least one of the buildings in the ROI by the input device such as mouse, as depicted in FIG. 2B. Additionally, the entity may provide one or more parameters for the selected pre-defined area. The one or more parameters may include any or a combination of core height, parapet height, tilt, azimuth, or the like.

In an embodiment, the processor 108 may be configured to receive a second set of data packets pertaining to one or more obstructions in the pre-defined area of the ROI. The one or more obstructions may be selected by the entity by the input device 106 as depicted in FIG. 2C. The one or more obstructions may include such as but not limited to skylight, pole, chimney, vent, and tree in proximity of the roof. For example, solar panels can be installed only in vacant area on the roof, obstructions available on the roof, cannot be covered by the solar panels, similary, when shadow of tree is occurring, in that area also, solar panels cannot be installed, as they may not receive required sunlight. Thus, obstructions are also selected by the entity.

In an embodiment, the processor 108 may be configured to generate a digital surface model (DSM) of the pre-defined area and the one or more obstructions selected by the entity. The digital surface model (DSM) is a raster-based description of the terrain that includes objects on the terrain, such as buildings and vegetation. Additionally, the processor 108 obtains DSM data of the pre-defined area and the one or more obstructions selected by the entity, further parse, the obtained DSM data, and correspondingly delivers a raster image and associated metadata. The DSM data may be received in tag image file format (TIFF). Moreover, the processor 108 creates a 3D mesh of a roof from the received raster image and the associated metadata. In some embodiments, color coding in the 3D mesh may be based on height of each point.

In an embodiment, based on the received one or more parameters from the entity, the processor 108 create and update one or more roof models. Further, corresponding to the one or more roof models, renders, on the graphical user interface (GUI), a visualization indicative of a plurality of solar panels over the pre-defined area, as depicted in FIG. 2D. It is clearly visible in FIG. 2D, that solar panels are not displayed on position of obstructions, and the solar panels are tilted at provided value of tilt. Additionally, a 3D model of the plurality of solar panels over the pre-defined area is shown. The entity may select an option from the GUI, to display the 3D model of the plurality of solar panels over the pre-defined area.

In an exemplary embodiment, the solar panels actually made up of groups of photovoltaic (PV) cells that take energy from Sun to produce electricity. These photovoltaic cells convert sunlight into electricity by establishing an electric field between a positive charge on one side and a negative charge on the other. The PV cells are arranged together in groups to form the solar panels that can generate electricity The solar panels can also be arranged together to form a solar array. The more solar panels are used, the more energy can be generated. Size of the solar panels and arrangement of the solar panels can be taken as attributes of the solar panel required for solar installation in the ROI.

In an embodiment, the one or more roof models may be further used for heat map generation and enables the entity to identify the roof and the one or more obstructions easily. In an exemplary embodiment, the heat map can be generated from trained classifiers, and the heat map can be generated through use of trained convolutional neural networks (CNNs), where either a sparse or a dense application of the heat map can be applied to an input image.

In an embodiment, visualization indicative of the plurality of solar panels of the roof may be downloaded from the computing device, by selecting various roof models. Also, components required while selecting at least one of the roof models can be evaluated. The components may be solar panel, inverter, DC disconnect, AC disconnect, meter, wire, charge controller, battery, junction box, combiner box, circuit breaker, fuse, load center, rapid shutdown, surge device, or the like. Further based on the required components cost of solar installation on the roof may be evaluated and displayed to the GUI of the computing device. This enable the service provider to provide exemplary roof models, components requirement, and cost prior to installing the solar panels to customers. Further, based on customers' requirements, cost, or other factors, roof models and components may be updated easily by the proposed system.

In an exemplary embodiment, the GUI receives inputs, i.e. selected area of roof, obstructions on the roof, and parameters from the user, the user can be a customer, a service provider, or the like. The GUI may be presented to the user on the associated computing device via a web browser or a native application executing on the computing device. The computing device may be connected to a network, for example, a wired local area network (LAN), a wireless local area network (WLAN), personal area network (PAN), wide area network (WAN), enterprise private network (EPN), and internet, or the like.

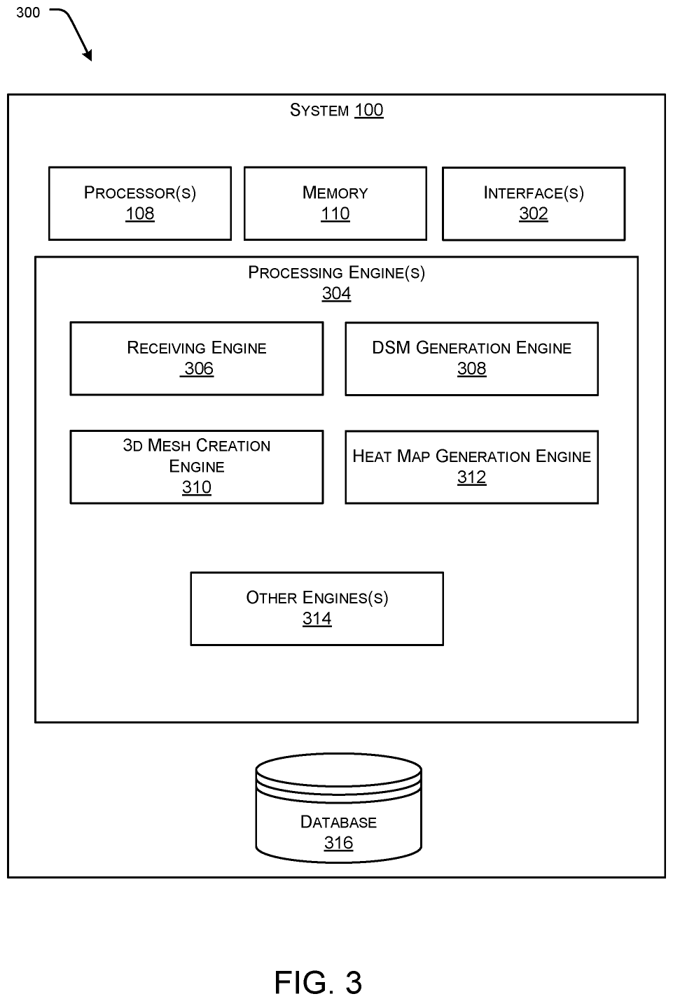

FIG. 3 illustrates exemplary functional components of a processing engine of the system, in accordance with an embodiment of the present disclosure. In an embodiment, a system 100 includes a processor 108, a memory 110, and one or more interface(s) 302. The interface 302 may include a variety of interfaces, for example, interfaces for data input and output devices referred to as I/O devices, storage devices, and the like. The interface 302 may also provide a communication pathway for one or more components of system 100. Examples of such components include, but are not limited to, a processing engine 304 and a database 316.

The processing engine 304 is provided with the processor 102, and it can be implemented as a combination of hardware and programming (for example, programmable instructions) to implement one or more functionalities of the processing engine 304. In examples described herein, such combinations of hardware and programming may be implemented in several different ways. For example, the programming for the processing engine 304 may be processing unit executable instructions stored on a non-transitory machine-readable storage medium, and the hardware for the processing engine 304 may include a processing resource (for example, one or more processors), to execute such instructions. In the present examples, the machine-readable storage medium may store instructions that, when executed by the processing resource, implement the processing engine 304. In such examples, the processing engine 304 can include the machine-readable storage medium storing the instructions and the processing resource to execute the instructions, or the machine-readable storage medium may be separate but accessible to the processor 102 and the processing resource. In other examples, the processing engine 304 can be implemented by electronic circuitry.

In an embodiment, the processing engine 304 includes a receiving engine 306, a DSM generation engine 308, a 3D mesh creation engine 310, a heat map generation engine 312, and other engine(s) 314. The other engine(s) 314 can implement functionalities that supplement applications or functions performed by system 100 or the processing engine 304. It would be appreciated that the modules being described are only exemplary modules and any other modules or sub-modules may be included as part of system 100. These units too may be merged or divided into super-modules or sub-modules as may be configured. In addition, database 316 includes data that is either stored or generated as a result of functionalities implemented by any of the components of system 100.

In an embodiment, the receiving engine 306 may be configured to receive, a first set of data packets pertaining to a pre-defined area of a region of interest (ROI), and the pre-defined area is selected by an entity by an input device 106. Additionally, the receiving engine 306 may be configured to receive a second set of data packets pertaining to one or more obstructions in the pre-defined area of the ROI, and the one or more obstructions may be selected by the entity by the input device 106. Moreover, the receiving engine 306 may be configured to receive one or more parameters such as height, tilt, or the like from the entity.

In an embodiment, the DSM generation engine 308 may be configured to generate a digital surface model (DSM) of the pre-defined area and the one or more obstructions selected by the entity. Also, the DSM generation engine 308 obtains DSM data of the pre-defined area and the one or more obstructions selected by the entity, and parse the obtained DSM data, and correspondingly delivers a raster image and associated metadata.

In an embodiment, the 3D mesh creation engine 310 may be configured to create a 3D mesh of a roof from the received raster image and the associated metadata. Further corresponding to the received input, the 3D mesh creation engine 310 may be configured to create and update one or more roof models, and corresponding to the one or more roof models renders, on a graphical user interface (GUI), a visualization indicative of a plurality of solar panels over the pre-defined area.

In an embodiment, the heat map generation engine 312 may be configured to generate a heat map of the pre-defined area where solar installation is required, when the entity selects an option of heat map provided on the GUI.

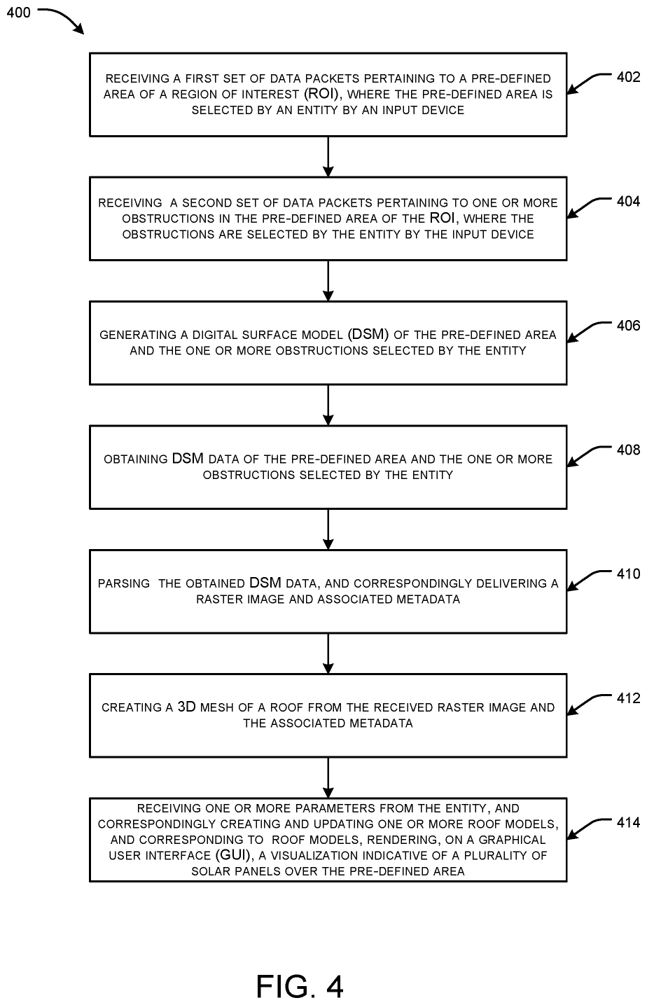

FIG. 4 illustrates a flow chart of a process for modeling model a roof in a geographical location, in accordance with an embodiment of the present disclosure.

As illustrated, a flow chart 400 is disclosed, at block 402, a method 400 includes receiving at a processor 108, a first set of data packets pertaining to a pre-defined area of a region of interest (ROI). The pre-defined area may be selected by an entity by an input device 106.

As illustrated, at block 404, the method 400 includes receiving at the processor 108, a second set of data packets pertaining to one or more obstructions in the pre-defined area of the ROI. The one or more obstructions may be selected by the entity by the input device 106.

As illustrated, at block 406, the method 400 includes generating by the processor 108 a digital surface model (DSM) (i.e. in TIFF format) of the pre-defined area and the one or more obstructions selected by the entity.

As illustrated, at block 408, the method 400 includes obtaining by the processor 108, DSM data of the pre-defined area and the one or more obstructions selected by the entity.

As illustrated, at block 410, the method 400 includes parsing at the processor 108, the obtained DSM data, and correspondingly delivering a raster image and associated metadata.

As illustrated, at block 412, the method 400 includes creating at the processor 108, a 3D mesh of a roof from the received raster image and the associated metadata.

As illustrated, at block 414, the method 400 includes receiving one or more parameters such as height, tilt, and etc. from the entity, and correspondingly creating and updating one or more roof models. Further, corresponding to the one or more roof models, the method may include rendering on a graphical user interface (GUI), a visualization indicative of a plurality of solar panels over the pre-defined area. The one or more roof models are used for heat map generation and enabling the entity to identify the roof and the one or more obstructions.

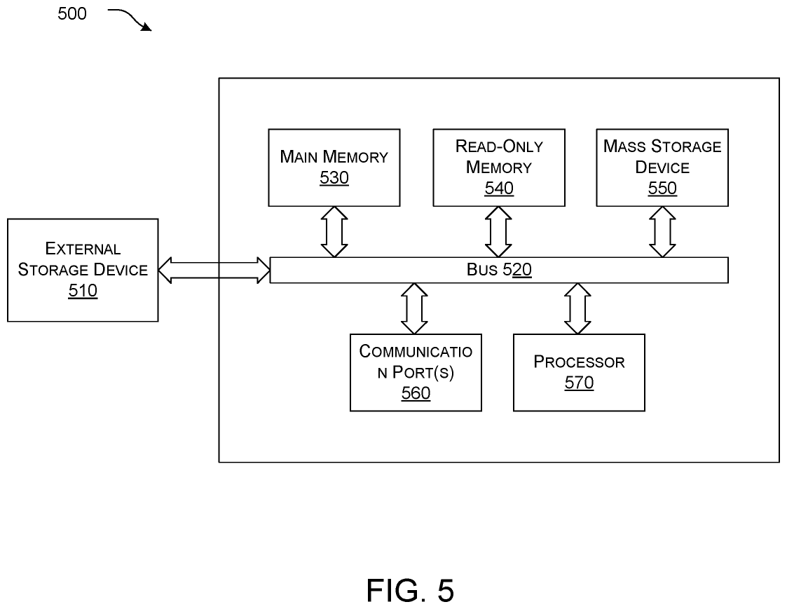

FIG. 5 illustrates an exemplary computer system to implement proposed system, in accordance with an embodiment of the present disclosure. As shown in FIG. 5, a computer system 500 can include an external storage device 510, a bus 520, a main memory 530, a read only memory 540, a mass storage device 550, a communication port 560, and a processor 570. A person skilled in the art will appreciate that the computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 570 may include various modules associated with embodiments of the present invention. Communication port 560 can be any of an RS-232 port for use with a modem-based dialup connection, a 10/100 Ethernet port, a Gigabit or 10 Gigabit port using copper or fibre, a serial port, a parallel port, or other existing or future ports. Communication port 560 may be chosen depending on a network, such a Local Area Network (LAN), Wide Area Network (WAN), or any network to which computer system connects. Memory 530 can be Random Access Memory (RAM), or any other dynamic storage device commonly known in the art. Read-only memory 540 can be any static storage device(s) e.g., but not limited to, a Programmable Read Only Memory (PROM) chips for storing static information e.g., start-up or BIOS instructions for processor 570. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 520 communicatively couples processor(s) 570 with the other memory, storage, and communication blocks. Bus 520 can be, e.g., a Peripheral Component Interconnect (PCI)/PCI Extended (PCI-X) bus, Small Computer System Interface (SCSI), USB, or the like, for connecting expansion cards, drives and other subsystems as well as other buses, such a front side bus (FSB), which connects processor 570 to software system.

Optionally, operator and administrative interfaces, e.g., a display, keyboard, and a cursor control device, may also be coupled to bus 520 to support direct operator interaction with a computer system. Other operator and administrative interfaces can be provided through network connections connected through communication port 560. The external storage device 510 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Embodiments disclosed herein provide system and method to improve accuracy by using digital surface model (DSM) data to create 3D models, and the resulting models are highly accurate and precise, providing detailed information about shape, size, and elevation of roofs and obstructions, also reducing time taken in roof creation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced.

Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to those having ordinary skill in the art.

### ADVANTAGES OF THE INVENTION

The present disclosure provides a system and method to automate process of modeling roofs and obstructions in a geographical location.

The present disclosure provides a system and method to improve accuracy by using digital surface model (DSM) data to create 3D models, and the resulting models are highly accurate and precise, providing detailed information about shape, size, and elevation of roofs and obstructions.

The present disclosure provides a system and method to better visualization of structure of roofs and obstructions.

The present disclosure provides a system and method to create 3D models using DSM data, thus costs associated with traditional surveying methods are reduced.

The present disclosure provides a system and method to reduce time taken in roof creation.

We claim:

1. A method for modeling a roof in a geographical area for solar installation, the method comprising:
receiving, at a processor, a first set of data packets pertaining to a pre-defined area of a region of interest (ROI), wherein the pre-defined area is selected by an entity by an input device;
receiving, at the processor, a second set of data packets pertaining to one or more obstructions in the pre-defined area of the ROI, wherein the one or more obstructions are selected by the entity by the input device;
generating, by the processor, a digital surface model (DSM) of the pre-defined area and the one or more obstructions selected by the entity;
obtaining, by the processor, DSM data of the pre-defined area and the one or more obstructions selected by the entity;
parsing, at the processor, the obtained DSM data, and correspondingly delivering a raster image and associated metadata;
creating, at the processor, a 3D mesh of a roof from the received raster image and the associated metadata; and
receiving, one or more parameters from the entity, and correspondingly creating and updating one or more roof models, and wherein corresponding to the one or more roof models, rendering, on a graphical user interface (GUI), a visualization indicative of a plurality of solar panels over the pre-defined area.

2. The method as claimed in claim 1, wherein the one or more parameters comprise any or a combination of core height, parapet height, tilt, and azimuth.

3. The method as claimed in claim 1, wherein color coding in the 3D mesh based on height of each point.

4. The method as claimed in claim 1, wherein the DSM data is received in tag image file format (TIFF).

5. The method as claimed in claim 1, wherein the one or more roof models are used for heat map generation and enabling the entity to identify the roof and the one or more obstructions.

6. The method as claimed in claim 1, wherein the one or more obstructions comprise any or combination of skylight, pole, chimney, vent, and tree in proximity of the roof.

7. A system (100) to model a roof in a geographical area for solar installation, the system comprising:
a processor (108); and
a memory (110) storing instructions that, when executed by the processor, cause the processor to perform:
receive, a first set of data packets pertaining to a pre-defined area of a region of interest (ROI), wherein the pre-defined area is selected by an entity by an input device;
receive, a second set of data packets pertaining to one or more obstructions in the pre-defined area of the ROI, wherein the one or more obstructions are selected by the entity by the input device;
generate, a digital surface model (DSM) of the pre-defined area and the one or more obstructions selected by the entity;
obtain, DSM data of the pre-defined area and the one or more obstructions selected by the entity;
parse, the obtained DSM data, and correspondingly delivers a raster image and associated metadata;
create, a 3D mesh of a roof from the received raster image and the associated metadata; and
receive, one or more parameters from the entity, and correspondingly create and update one or more roof models, and wherein corresponding to the one or more roof models renders, on a graphical user interface (GUI), a visualization indicative of a plurality of solar panels over the pre-defined area.

8. The system as claimed in claim 7, wherein the one or more parameters comprise any or a combination of core height, parapet height, tilt, and azimuth.

9. The system as claimed in claim 7, wherein the one or more roof models are used for heat map generation and enable the entity to identify the roof and the one or more obstructions.

10. The system as claimed in claim 7, wherein the one or more obstructions comprise any or a combination of skylight, pole, chimney, vent, and tree in proximity of the roof.
